(19) United States
(12) Patent Application Publication
(10) Pub. No.: US 2026/0241471 A1
(43) Pub. Date: Aug. 20, 2026

(54) ROTARY TOOL ATTACHMENT FOR EDGE MATERIAL REMOVAL AND FASTENER DRIVING

(71) Applicant: Michael Lewis, West Hills, CA (US)

(72) Inventor: Michael Lewis, West Hills, CA (US)

(21) Appl. No.: 19/641,319

(22) Filed: Apr. 7, 2026

(51) Int. Cl. B23D 71/00; B25B 23/00

(52) U.S. Cl. CPC B23D 71/005; B25B 23/0035

(57) ABSTRACT

A rotary tool attachment includes a proximal drive interface configured for engagement with a powered rotary driver, an elongate body, a distal bit-holding portion configured to receive or retain a removable driver bit, and a material-removal region disposed on an intermediate outer portion of the elongate body between the proximal drive interface and the distal bit-holding portion. The material-removal region is configured to remove material from a surface region of a workpiece during rotation of the attachment, including engagement with an edge or boundary region of the workpiece. In certain embodiments, the attachment is configured such that both material-removal and fastener-driving functions are simultaneously available while the attachment remains mounted to the powered rotary driver, thereby enabling shaping and fastening operations without requiring removal or reconfiguration of the attachment.

### CROSS-REFERENCE TO RELATED APPLICATIONS

This application claims the benefit of U.S. Provisional Patent Application No. 63/974,371, filed on Feb. 2, 2026, the entire contents of which are hereby incorporated by reference herein.

### FIELD OF THE INVENTION

The present invention related to rotary driver-compatible tool attachments configured for both material removal and fastener driving.

### BACKGROUND

Conventional drywall and panel installation commonly requires multiple separate tools during fitting and fastening operations. For example, a user may first need to smooth, shave, shape, or otherwise remove material from an uneven edge of a drywall panel and then separately use a powered driver to install a fastener. In practice, these tasks often require switching between a rasp, file, sanding tool, shaping tool, knife, or other material-removal implement and a driver bit or fastening tool.

This repeated tool switching may be inconvenient, time-consuming, and inefficient, particularly when performed on ladders, scaffolds, elevated work areas, or in other installation environments where maintaining workflow continuity is desirable. In addition, the need to alternate between separate shaping and fastening tools may interrupt positioning, reduce efficiency, and increase the likelihood of dropped tools, repeated repositioning, or loss of balance during use.

Various rotary shaping tools, abrasive tools, rasps, burrs, and fastening accessories are known in the art. However, such tools generally are not configured to provide both a material-removal region and a distal fastener-driving capability in a single driver-compatible attachment that can remain mounted to a powered rotary driver during use.

Accordingly, a need exists for an improved tool attachment that facilitates both localized material removal and fastener-driving functionality in a single rotary driver-compatible configuration.

### SUMMARY OF INVENTION

The present invention provides a rotary tool attachment configured for both material-removal and fastener-driving operations.

In one aspect, a rotary tool attachment includes a proximal drive interface configured for engagement with a powered rotary driver, an elongate body extending distally from the proximal drive interface, a distal bit-holding portion configured to receive or retain a removable driver bit, and a material-removal region disposed on an intermediate outer portion of the elongate body between the proximal drive interface and the distal bit-holding portion.

In certain embodiments, the material-removal region is configured to remove material from a surface region of a workpiece during rotation of the tool attachment while the tool attachment remains mounted to the powered rotary driver.

In certain embodiments, the distal bit-holding portion is configured to receive a removable driver bit such that fastener-driving functionality remains available while the tool attachment is mounted to the powered rotary driver.

In certain embodiments, the tool attachment is configured such that both the material-removal region and the distal bit-holding portion remain simultaneously accessible and operable while the tool attachment remains mounted to the powered rotary driver, thereby permitting a user to perform material-removal and fastener-driving operations without requiring removal, repositioning, or reconfiguration of the tool attachment.

In certain embodiments, the material-removal region may comprise an abrasive, roughened, textured, patterned, or otherwise configured material-removal working surface suitable for controlled removal of drywall, gypsum board, or other panel, board, sheet, or edge-defining material.

In certain embodiments, the material-removal region may be configured to contact an edge, corner, transition, or other boundary region of a workpiece using an outer side surface of the tool attachment during rotation.

These and other features and advantages of the invention will become more apparent from the following description of illustrated embodiments and the accompanying drawings.

### BRIEF DESCRIPTION OF THE DRAWINGS

FIG. 1—Side elevation view of the tool

FIG. 2—Exploded view of the tool

FIG. 3—Cross-sectional detail view of a material-removal region

FIG. 4—Perspective view of a drywall workpiece

FIG. 5—Perspective view of the tool engaged with the drywall workpiece

### DETAILED DESCRIPTION

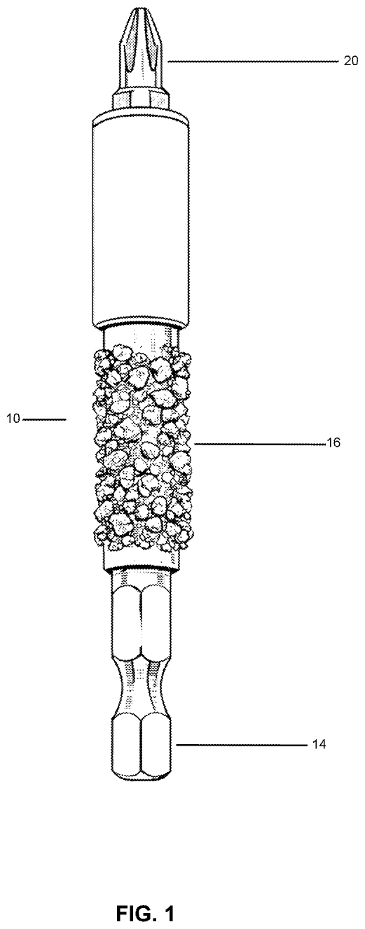

Referring to FIG. 1, a tool 10 is shown according to an embodiment of the present invention. The tool 10 includes a proximal drive interface 14, a material-removal region 16, and a removable driver bit 20.

The proximal drive interface 14 is configured to be received by a powered driver or drill, allowing rotational force to be applied to the tool 10. In various embodiments, the proximal drive interface 14 may comprise a hex shank or other conventional drive geometry suitable for engagement with a chuck or quick-release mechanism.

The material-removal region 16 is disposed on an intermediate outer portion of the elongate body of the tool 10, between the proximal drive interface 14 and the removable driver bit 20 and is configured to remove material from a workpiece during rotation. As discussed further below, the material-removal region 16 may include a material-removal working surface formed using conventional abrasive application techniques or other suitable material-removal structures.

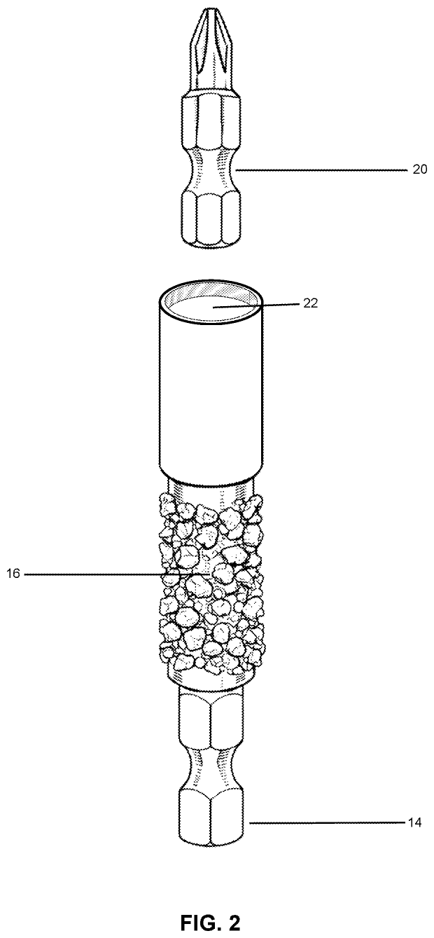

The removable driver bit 20 is positioned at a distal end of the tool 10 and is configured to engage a fastener. In certain embodiments, the tool 10 includes a distal bit-holding portion configured to receive, support, or retain the removable driver bit 20, such as through the bit-receiving interface 22, (see FIG. 2). In certain embodiments, the removable driver bit 20 extends distally beyond the material-removal region 16.

In certain embodiments, the distal bit-holding portion is positioned relative to the material-removal region such that a removable driver bit extends distally beyond at least a portion of the material-removal region, thereby permitting fastener engagement without interference from the material-removal region.

Referring to FIG. 2, the tool 10 is shown in an exploded configuration. The removable driver bit 20 is separable from the tool body and is received within the bit-receiving interface 22. The bit-receiving interface 22 may include a hexagonal or other shaped cavity configured to securely retain the removable driver bit 20, optionally via magnetic retention, friction fit, detent retention, spring retention, or other known retention mechanisms.

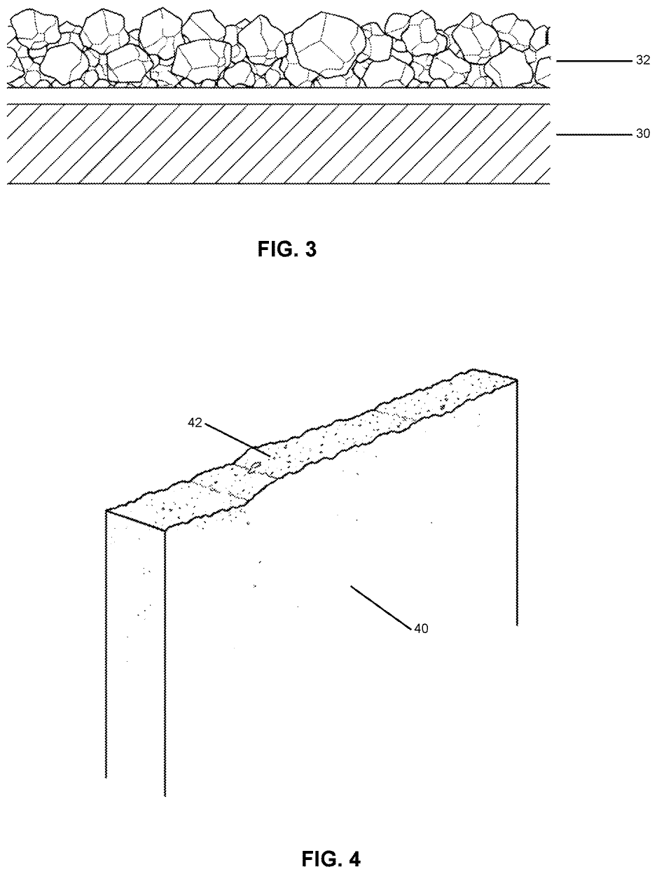

Referring to FIG. 3, a detailed view of the material-removal region 16 is shown. The material-removal region 16 may comprise a substrate 30 having an abrasive material 32 applied to an outer surface thereof.

The material-removal region 16 may comprise an abrasive surface formed on or secured to an outer portion of the elongate body. In various embodiments, the abrasive surface may be provided using any suitable abrasive application or retention technique known in the art, including but not limited to bonded abrasive particles, plated or deposited abrasive media, coated abrasive materials, embedded abrasive structures, or other conventional abrasive surface treatments.

The specific method of forming or securing the abrasive material 32 is not critical to the present invention and may be implemented using standard or known abrasive manufacturing techniques.

Accordingly, the material-removal region 16 should not be interpreted as being limited to any particular abrasive composition, particle size, bonding method, or surface treatment configuration.

More generally, the material-removal region 16 may include abrasive, roughened, textured, patterned, or other material-removal structures suitable for controlled removal of drywall, gypsum, or similar workpiece material.

Referring to FIG. 4, a workpiece is shown in the form of a drywall workpiece 40 having an uneven edge 42. The uneven edge 42 may result from cutting, scoring, snapping, breaking, or otherwise shaping drywall material and may require smoothing or shaping prior to finishing or installation.

The tool 10 may be used to remove material from an edge, corner, transition, or other boundary region of a workpiece.

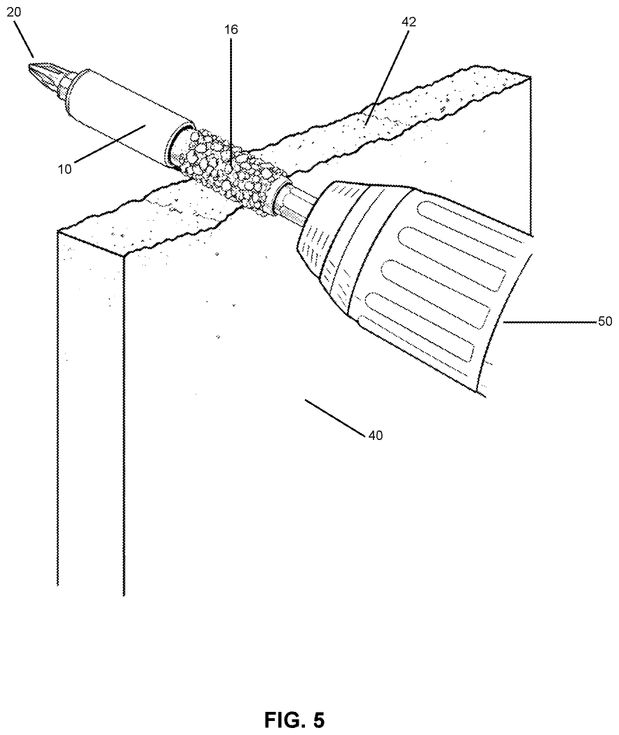

Referring to FIG. 5, the tool 10 is shown in use with the drywall workpiece 40. The proximal drive interface 14 is engaged with a powered driver 50, which rotates the tool 10. The material-removal region 16 contacts the uneven edge 42 of the drywall workpiece 40 to remove material and smooth or shape the edge.

In certain embodiments, material removal is performed by rotational contact between an outer side surface of the material-removal region 16 and the uneven edge 42 of the drywall workpiece 40. In some embodiments, the material-removal region 16 may comprise a generally cylindrical outer working surface.

In certain embodiments, the material-removal region 16 is configured for lateral engagement with a surface region of a workpiece, including an edge, corner, or boundary region, during rotation of the tool. The material-removal region may engage the workpiece using an outer surface of the elongate body to facilitate controlled material removal.

In certain embodiments, the removable driver bit 20 and the material-removal region 16 are both available while the tool 10 remains mounted to the powered driver 50, thereby enabling both material-removal and fastener-driving operations using a single mounted tool configuration.

In certain embodiments, the tool permits transition between material-removal and fastener-driving operations without removal, repositioning, or reconfiguration of the tool attachment, thereby enabling continuous workflow during use.

In some embodiments, the material-removal region 16 may be dimensioned such that at least a portion of the region can be aligned with, straddle, or nest against an edge or corner of a drywall workpiece 40 during use, thereby facilitating controlled material removal along the edge.

Although the illustrated embodiments are shown in connection with drywall, the tool 10 may also be used with other panel, board, sheet, or edge-defining materials where localized material removal, smoothing, shaping, or edge refinement is desired.

While specific embodiments have been described, it will be understood that various modifications, variations, and alternative configurations may be employed without departing from the scope of the invention.

1. A rotary tool attachment comprising:
a proximal drive interface configured for engagement with a powered rotary driver;
an elongate body extending distally from the proximal drive interface along a longitudinal axis;
a distal bit-holding portion configured to receive or retain a removable driver bit; and
a material-removal region disposed along at least a portion of an outer surface of the elongate body between the proximal drive interface and the distal bit-holding portion,
wherein the material-removal region is configured to remove material from a surface region of a workpiece by rotational contact between the outer surface of the elongate body and the workpiece, including lateral engagement of the material-removal region with an edge, corner, or boundary region of the workpiece;
wherein the distal bit-holding portion is positioned relative to the material-removal region such that the removable driver bit extends distally beyond at least a portion of the material-removal region; and
wherein the rotary tool attachment is configured such that both (i) the material-removal region and (ii) the distal bit-holding portion with the removable driver bit remain simultaneously accessible and operable for material-removal and
fastener-driving operations while the rotary tool attachment remains mounted to the powered rotary driver, without requiring removal, repositioning, or reconfiguration of the rotary tool attachment between such operations.

2. The rotary tool attachment of claim 1, wherein the proximal drive interface comprises a shank configured for releasable engagement with a chuck or quick-release driver.

3. The rotary tool attachment of claim 1, wherein the distal bit-holding portion comprises a bit-receiving interface configured to removably receive the removable driver bit.

4. The rotary tool attachment of claim 3, wherein the bit-receiving interface is configured to retain the removable driver bit by magnetic retention, friction fit, detent retention, spring retention, or a combination thereof.

5. The rotary tool attachment of claim 1, wherein the material-removal region comprises a material-removal working surface disposed on the elongate body.

6. The rotary tool attachment of claim 5, wherein the material-removal working surface comprises abrasive material secured to the elongate body using a bonded, plated, deposited, coated, embedded, or otherwise retained abrasive structure.

7. The rotary tool attachment of claim 1, wherein the material-removal region is configured to contact and remove material from a drywall or gypsum-based workpiece during rotation.

8. The rotary tool attachment of claim 7, wherein the material-removal region is dimensioned such that at least a portion of the material-removal region can align with, straddle, or nest against an edge of the workpiece during use.

9. The rotary tool attachment of claim 1, wherein the removable driver bit comprises a Phillips, Torx, square-drive, hex-drive, slotted, or other fastener-driving bit.

10. The rotary tool attachment of claim 1, wherein the material-removal region and the distal bit-holding portion are simultaneously usable during operation.

11. The rotary tool attachment of claim 1, wherein the material-removal region comprises a generally cylindrical outer working surface.

12. The rotary tool attachment of claim 1, wherein the removable driver bit extends distally beyond the material-removal region.

13. The rotary tool attachment of claim 1, wherein the material-removal region comprises a non-uniform outer profile selected from cylindrical, tapered, faceted, concave, convex, or combinations thereof.

14. The rotary tool attachment of claim 1, wherein the material-removal region includes one or more grooves, channels, or discontinuities configured to facilitate removal of debris during material-removal operations.

15. The rotary tool attachment of claim 1, wherein the material-removal region comprises an abrasive element that is configured to be removable or replaceable.

16. The rotary tool attachment of claim 1, wherein the distal bit-holding portion includes a magnetic retention mechanism configured to retain the removable driver bit during material-removal operations.

17. The rotary tool attachment of claim 1, wherein the distal bit-holding portion is positioned to permit fastener engagement without interference from the material-removal region.

18. A method of using a rotary tool attachment, comprising:
mounting the rotary tool attachment to a powered rotary driver;
engaging a material-removal region of the rotary tool attachment with a surface region of a workpiece while rotating the rotary tool attachment to remove material from the workpiece; and
subsequently driving a fastener into the workpiece using a driver bit retained in a distal bit-holding portion of the rotary tool attachment,
wherein the rotary tool attachment remains mounted to the powered rotary driver during both the material-removal and fastener-driving steps without requiring removal, repositioning, or reconfiguration of the rotary tool attachment.
